(19) United States
(12) Patent Application Publication
(10) Pub. No.: US 2021/0033155 A1
(43) Pub. Date: Feb. 4, 2021

(54) VALVE ASSEMBLIES WITH CLUTCHES ADAPTED FOR DUAL VALVE MEMBER ACTUATION

(71) Applicant: Aventics Corporation, Lexington, KY (US)

(72) Inventors: Oswald Baasch, Bowling Green, KY (US); Stefan B. Holder, Alvaton, KY (US); Jon A. Bigley, Bowling Green, KY (US)

(21) Appl. No.: 16/942,159

(22) Filed: Jul. 29, 2020

Related U.S. Application Data
(60) Provisional application No. 62/880,077, filed on Jul. 29, 2019.

(51) Int. Cl. F16D 48/02; F16D 11/14; F16K 1/20

(52) U.S. Cl. CPC F16D 25/14; F16K 1/2021; F16K 1/2007; F16D 11/14

(57) ABSTRACT

Valve assemblies with clutches adapted for dual valve member actuation. A valve assembly includes a valve body that includes a first portion and a second portion, a bore, a primary opening, and a secondary opening. A primary valve shaft is disposed within the bore and has a primary end portion, the secondary valve shaft is disposed within the bore and has a secondary end portion facing the primary end portion of the primary valve shaft. A primary valve member is movable relative to the primary opening and coupled to the primary valve shaft, the secondary valve member is movable relative to the secondary opening and coupled to the secondary valve shaft. A clutch is shiftable between a first position enabling the primary valve shaft to move independently of the secondary valve shaft and a second position enabling the secondary valve shaft to move with the primary valve shaft.

### FIELD OF THE DISCLOSURE

The present patent relates generally to valve assemblies and, in particular, to valve assemblies with clutches adapted for dual valve member actuation.

### BACKGROUND

Diesel or gas engines may include an exhaust manifold, a Turbo Charger, and an exhaust gas recirculation (EGR) valve. In operation, the EGR valve routes a portion of exhaust gases from the exhaust manifold back to the Turbo Charger to allow the exhaust gases to be re-burned, thereby reducing Nitrogen Oxide emissions

### SUMMARY

In accordance with a first example, a valve assembly includes a valve body, a primary valve shaft, a secondary valve shaft, a primary flap, a secondary shaft, and a clutch. The valve body includes a bore, a primary flap opening disposed adjacent to the bore and a secondary flap opening disposed adjacent to the primary flap opening. The primary valve shaft is disposed within the bore and has a primary end portion. The secondary valve shaft is disposed within the bore and has a secondary end portion facing the primary end portion of the primary valve shaft. The primary flap is disposed within the primary flap opening and is coupled to the primary valve shaft and the secondary flap is disposed within the secondary flap opening and is coupled to the secondary valve shaft. The clutch is shiftable between a first position, in which the clutch is spaced from one of the primary and secondary end portions, such that the primary valve shaft is movable independently of the secondary valve shaft, and a second position, in which the clutch engages each of the primary and secondary end portions, such that the secondary valve shaft is movable with the primary valve shaft.

In accordance with a second example, a valve assembly includes a valve body, a primary actuator, a primary-valve shaft, a secondary-valve shaft, a primary flap, a secondary flap, and a clutch ring. The valve body includes a first portion and a second portion, a bore including a first-bore portion and a second-bore portion, a primary-flap opening, and a secondary-flap opening. The primary actuator is coupled to the first portion of the valve body and the primary-valve shaft is disposed within the first-bore portion and has a first portion and a second portion. The first portion of the primary-valve shaft is coupled to the rotary actuator and the second portion of the primary-valve shaft has external splines. The secondary-valve shaft is disposed within the second-bore portion and has a first portion and a second portion. The first portion of the secondary-valve shaft has external splines and faces the second portion of the primary-valve shaft. The primary flap is disposed within the primary-flap opening and has a yoke. The yoke of the primary-flap is coupled to the second portion of the primary-valve shaft. The secondary flap is disposed within the secondary flap opening and has a yoke. The yoke of the secondary flap is coupled to the first portion of the secondary-valve shaft. The clutch ring has internal spines. The clutch ring is shiftable between surrounding and having the internal splines mate with the external splines of one of the external splines of the primary-valve shaft or the external splines of the secondary-valve shaft surrounding and having the internal splines of the clutch ring mate with both of the external splines of the primary-valve shaft and the external splines of the secondary-valve shaft.

In accordance with a third example, a valve assembly includes a valve body, a primary valve shaft, a secondary valve shaft, a primary valve member, a secondary valve member, and a clutch. The valve body includes a first portion and a second portion, a bore, a primary opening disposed adjacent the bore, and a secondary opening disposed adjacent the primary opening and the bore. The primary valve shaft is disposed within the bore and has a primary end portion and the secondary valve shaft is disposed within the bore and has a secondary end portion facing the primary end portion of the primary valve shaft. The primary valve member is movable relative to the primary opening and is coupled to the primary valve shaft. The secondary valve member is movable relative to the secondary opening and is coupled to the secondary valve shaft. The clutch is shiftable between a first position enabling the primary valve shaft to move independently of the secondary valve shaft and a second position enabling the secondary valve shaft to move with the primary valve shaft.

In further accordance with the foregoing first, second, and/or third examples, an apparatus and/or method may further include or comprise any one or more of the following:

In accordance with an example, each of the primary and secondary end portions include external splines and the clutch includes a clutch ring having internal splines that engage the external splines when the clutch ring is in the second position.

In accordance with another example, each of the primary and secondary end portions includes internal splines and the clutch has external splines that engage the internal splines when the clutch is in the second position.

In accordance with another example, the primary flap has a primary yoke that is coupled to the primary valve shaft and the secondary flap has a secondary yoke that is coupled to the secondary valve shaft.

In accordance with another example, the valve assembly includes a rotary actuator coupled to the primary valve shaft to control a position of the primary valve shaft.

In accordance with another example, the valve assembly includes a clutch actuator adapted to shift the clutch between the first position and the second position.

In accordance with another example, the clutch actuator includes a solenoid valve.

In accordance with another example, the clutch includes an external groove. The valve assembly also includes a pivot arm including a first portion and a second portion. The first portion of the pivot arm is coupled to the clutch and the second portion of the pivot arm is coupled to the clutch actuator. Responsive to actuation by the clutch actuator, the first portion of the pivot arm engages a wall of the external groove of the clutch, thereby driving the clutch to the second position.

In accordance with another example, the valve assembly further includes a pivot pin extending through the pivot arm.

In accordance with another example, the valve body includes an access opening defined by the valve body between the primary flap opening and the secondary flap opening and providing access to the bore. The first portion of the pivot arm extends through the access opening of the valve body.

In accordance with another example, the valve assembly includes an actuator coupling that includes a flange and a housing having a bore. The flange is coupled to the valve body and has an access opening. The access opening of the flange is aligned with the access opening of the valve body. The clutch actuator has an actuator stem and is coupled to the housing of the actuator coupling. The actuator stem extends into the bore of the housing of the actuator coupling and is coupled to the second portion of the pivot arm.

In accordance with another example, the actuator stem has a groove. The second portion of the pivot arm at least partially surrounds the groove.

In accordance with another example, the groove of the stem has opposing convex portions.

In accordance with another example, the valve assembly includes a primary bushing and a secondary bushing. The primary bushing surrounds the primary valve shaft and is disposed within the bore. The secondary bushing surrounds the secondary valve shaft and is disposed within the bore.

In accordance with another example, the primary bushing includes a groove and the secondary bushing includes a groove. The valve assembly further includes pins to be received within the corresponding grooves.

In accordance with another example, the valve assembly includes a primary torsion spring and a secondary torsion spring. The primary torsion spring is arranged to bias the first portion of the primary valve shaft and the secondary torsion spring is arranged to bias the second portion of the secondary valve shaft.

In accordance with another example, the secondary torsion spring includes a first portion and a second portion. The first portion of the secondary torsion spring is coupled to the valve body and the second portion of the secondary torsion spring is coupled to the secondary valve shaft.

In accordance with another example, the valve assembly includes a clutch actuator adapted to shift the clutch ring between surrounding and having the internal splines mate with the external splines of one of the external splines of the primary-valve shaft or the external splines of the secondary valve shaft to surrounding and having the internal splines of the clutch ring mate with the external splines of both of the external splines of the primary-valve shaft and the external splines of the secondary valve shaft.

In accordance with another example, the clutch actuator includes one of a solenoid valve, a diaphragm actuator, a lead screw, a pneumatic actuator, or a pneumatic actuator.

In accordance with another example, the valve assembly includes a coupling between the clutch actuator and the clutch ring.

In accordance with another example, the coupling includes a pivot arm or an arm shiftable relative to a longitudinal axis of the primary-valve shaft and the secondary-valve shaft.

In accordance with another example, the secondary valve member includes one of a valve flap, a disk, or a valve plug.

In accordance with another example, each of the primary and secondary end portions includes internal splines and the clutch has external splines that engage the internal splines when the clutch is in the second position.

In accordance with another example, at least one of the primary end portion or the secondary end portion has a keyway and the clutch has a key that mates with the keyway when the clutch is in the second position.

In accordance with another example, at least one of the primary end portion or the secondary end portion has a female portion and the clutch has a male portion that mates with the female portion when the clutch is in the second position.

### BRIEF DESCRIPTION OF THE DRAWINGS

FIG. 1 illustrates a valve assembly assembled in accordance with a first disclosed example of the present invention.

FIG. 2 illustrates a detailed cross sectional view of the valve assembly of FIG. 1 with a clutch in a first position.

FIG. 3 illustrates a detailed cross sectional view of the valve assembly of FIG. 1 with a clutch in a second position.

FIG. 4 illustrates a detailed isometric view of the valve assembly of FIG. 1 with the clutch in the first position.

FIG. 5 illustrates a valve assembly assembled in accordance with a second disclosed example of the present invention.

FIG. 6 illustrates an isometric view of a portion of the valve assembly of FIG. 5.

FIG. 7 illustrates an isometric view of a portion of the valve assembly of FIG. 5.

### DETAILED DESCRIPTION

Although the following text discloses a detailed description of example methods, apparatus, and/or articles of manufacture, it should be understood that the legal scope of the property right is defined by the words of the claims set forth at the end of this patent. Accordingly, the following detailed description is to be construed as examples only and does not describe every possible example, as describing every possible example would be impractical, if not impossible. Numerous alternative examples could be implemented, using either current technology or technology developed after the filing date of this patent. It is envisioned that such alternative examples would still fall within the scope of the claims.

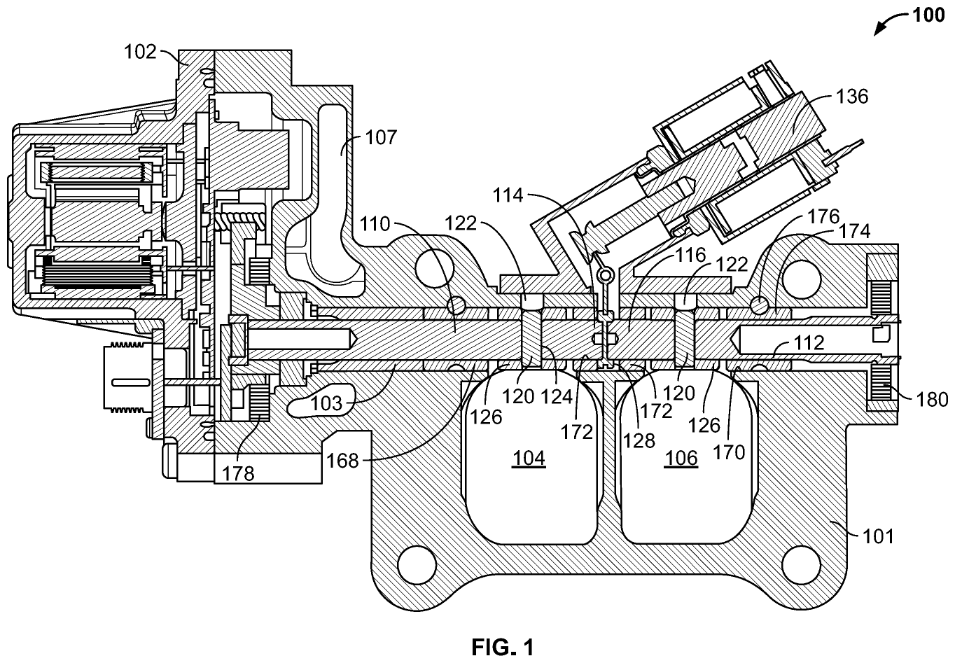

Referring now to the drawings, FIG. 1 illustrates a valve assembly 100 assembled in accordance with a first disclosed example of the present invention. In accordance with the disclosed example, the valve assembly 100 includes a valve body 101 and a rotary actuator 102.

The valve body 101 includes a bore 103, a primary flap opening 104, and a secondary flap opening 106. In the example shown, the primary flap opening 104 is disposed adjacent to the bore 103 and the secondary flap opening 106 is disposed adjacent to the primary flap opening 104. While two flap openings are shown, any other number of flap openings may be included such as, for example, three flap openings, four flap openings, etc. The valve body 101 also includes a coolant flow path 107.

The valve assembly 100 includes a primary valve shaft 110 and a secondary valve shaft 112. The primary valve shaft 110 is disposed within the bore 103 and includes a primary end portion 114. The rotary actuator 102 is coupled to the primary valve shaft 110 and is adapted to control a position of the primary valve shaft 110.

The secondary valve shaft 112 is disposed within the bore 103 and includes a secondary end portion 116 that faces the primary end portion 114 of the primary valve shaft 110.

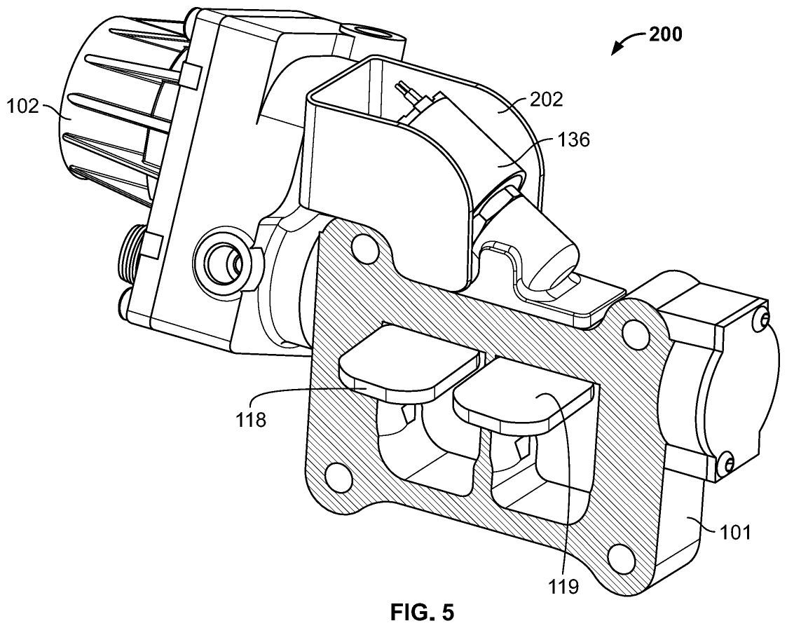

A primary flap 118 (the primary flap 118 is most clearly shown in FIG. 5) is disposed within the primary flap opening 104 and is coupled to the primary valve shaft 110. A secondary flap 119 (the secondary flap 119 is most clearly shown in FIG. 5) is disposed within the secondary flap opening 106 and is coupled to the secondary valve shaft 112. In the example shown, the primary flap 118 is coupled to the primary valve shaft 110 via a pin 120. The valve body 101 defines an access bore 122.

The access bore 122 of the valve body 101 allows the pin 120 to be positioned within a corresponding pin bore 124 of a primary yoke 126 of the primary flap 118, thereby coupling the primary flap 118 and the primary valve shaft 110. The secondary flap 119 is coupled to the secondary valve shaft 112 in a similar manner. While the example valve assembly 100 discloses the flap openings 104, 106 and the flaps 118, 119, the valve assembly 100 may be configured to use different types of valve members. For example, the opening 106 may be adapted to receive a valve member such as a disk or a plug (e.g., a linearly movable valve plug). Corresponding actuators and/or drives (e.g., lead screws) may be included to actuate the valve members in a rotational or linear manner.

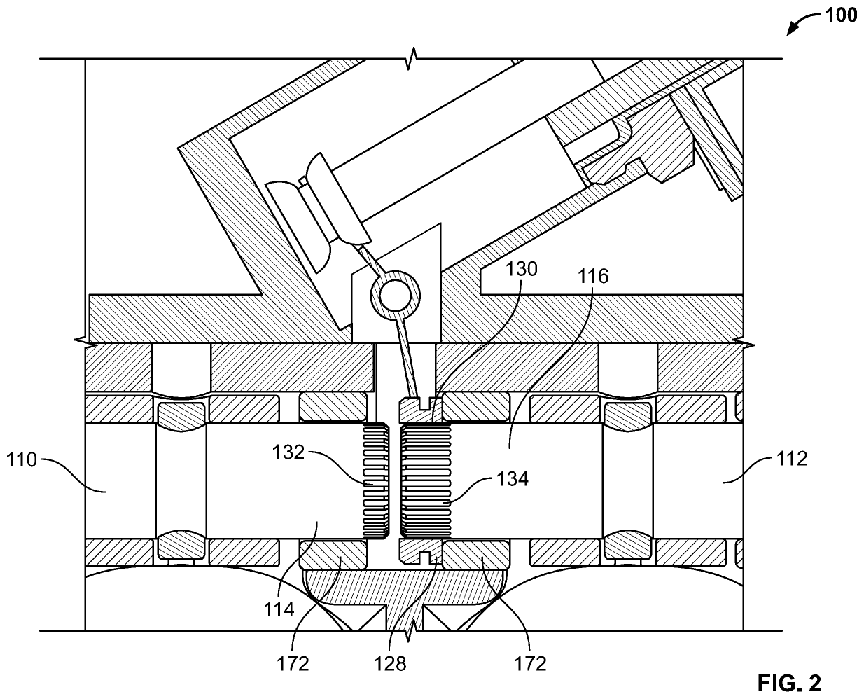

FIG. 2 illustrates a detailed cross sectional view of the valve assembly 100 of FIG. 1. In the example shown, the valve assembly 100 includes a clutch 128. The clutch 128 is a clutch ring or a ring gear having internal splines 130. The primary and secondary end portions 114, 116 have external splines 132, 134. The internal splines 130 of the clutch 128 are adapted to engage one of external splines 132, 134 of the valve shafts 110, 112 when the clutch 128 is in a first position, thereby allowing the primary valve shaft 110 to move independently of the secondary valve shaft 112. Thus, the flaps 118, 119 may be independently movable.

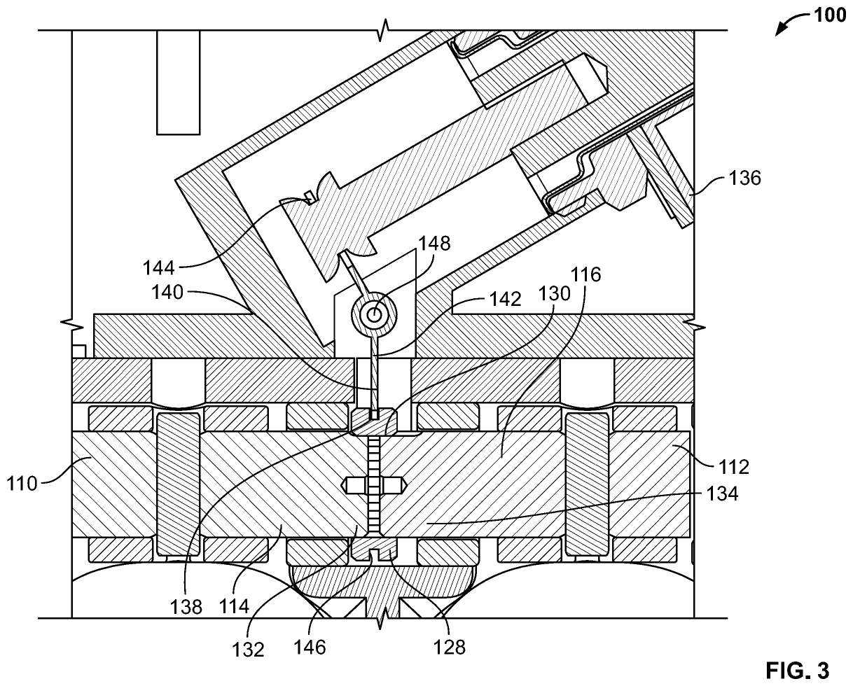

FIG. 3 illustrates a detailed cross sectional view of the valve assembly 100 of FIG. 1 with the clutch 128 in a second position. In the second position, the clutch 128 engages each of the primary and secondary end portions 114, 116 such that the secondary valve shaft 112 is movable with the primary valve shaft 110.

Alternatively, the primary and secondary end portions 114, 116 may have internal splines and the clutch 128 may have external splines. The external splines may be adapted to engage the internal splines of the primary and secondary end portions 114, 116 when the clutch 128 is in the second position.

As another alternative, the primary end portion 114 or the secondary end portion 116 may define a keyway and the clutch 128 may have a key that is adapted to mate with the keyway when the clutch 128 is in the second position. Put another way, the primary end portion 114 or the secondary end portion 116 may have a female portion and the clutch 128 may have a male portion that is adapted to mate with the female portion when the clutch 128 is in the second position.

The valve assembly 100 includes a clutch actuator 136. The clutch actuator 136 is adapted to shift the clutch 128 between the first position and the second position. The clutch actuator 136 is shown as a solenoid valve. However, other types of actuators may be used. For example, the clutch actuator 136 may alternatively be a diaphragm actuator, a lead screw, a pneumatic actuator, or a hydraulic actuator. While one clutch actuator is illustrated, when more than two flaps are provided and more than two shafts are provided, a corresponding number of clutch actuators may be included (e.g., three flaps, three shafts, two clutch actuators) all of which may be driven by the rotary actuator 102, for example.

In the example shown, the clutch 128 has an external groove 138 and the valve assembly 100 includes a pivot arm 140 having a first portion 142 and a second portion 144. The first portion 142 of the pivot arm 140 may have an arced portion or have a contour that mates with a contour of the external grove. In an example, the first portion 142 is a fork.

The first portion 142 of the pivot arm 140 and the second portion 144 of the pivot arm 140 are coupled to the clutch actuator 136. In response to actuation of the clutch actuator 136, the first portion 142 of the pivot arm 140 engages a wall 146 of the external groove 138 to drive the clutch 128 to the second position. Similarly, in response to actuation of the clutch actuator 136, the first portion 142 of the pivot arm 140 engages an opposing wall 146 of the external groove 138 to drive the clutch 128 to the first position. A pivot pin 148 is provided that extends through the pivot arm 140. While the example valve assembly 100 includes the pivot arm 140, the clutch 128 may be actuated in different ways. For example, an arm may alternatively be provided that is shiftable relative to a longitudinal axis of the primary valve shaft 110 and the secondary valve shaft 112. In such a configuration, the orientation of the clutch actuator 136 may change. For example, a longitudinal axis of the clutch actuator 136 may be substantially parallel to a longitudinal axis of the shafts 110, 112.

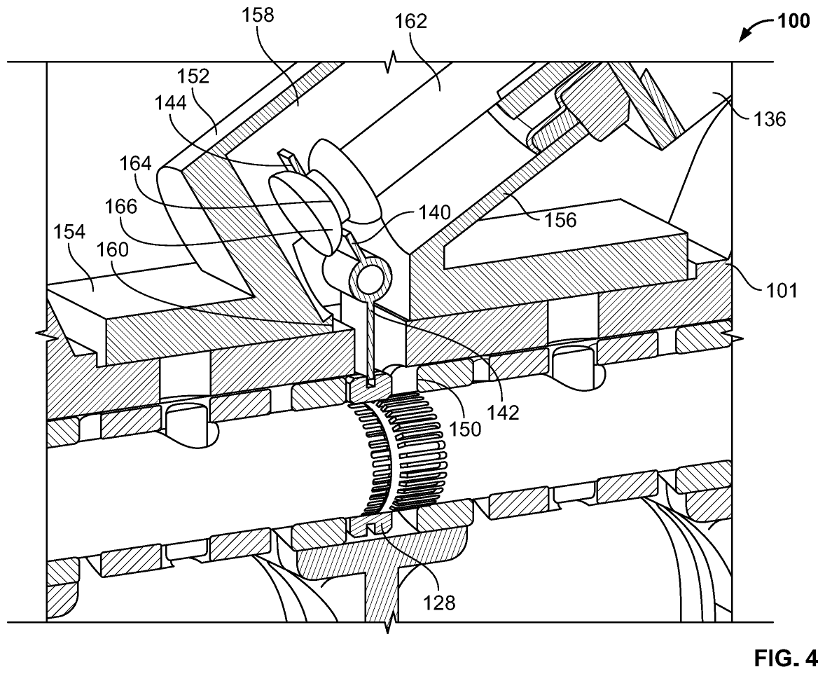

FIG. 4 illustrates a detailed isometric view of the valve assembly 100 of FIG. 1 with the clutch 128 in the first position. In the example shown, the valve body 101 has an access opening 150 defined between the primary flap opening 104 and the secondary flap opening 106 and providing access to the bore 103 of the valve body 101. The first portion 142 of the pivot arm 140 extends through the access opening 150 of the valve body 101.

The valve assembly 100 includes an actuator coupling 152 including a flange 154 and a housing 156 having a bore 158. The flange 154 is coupled to the valve body 101 and has an access opening 160 aligned with the access opening 150 of the valve body 101.

In the example shown, the clutch actuator 136 is coupled to the housing 156 of the actuator coupling 152 and has an actuator stem 162. The actuator stem 162 extends into the bore 158 of the housing 156 of the actuator coupling 152 and is coupled to the second portion 144 of the pivot arm 140. The actuator stem 162 has a groove 164 that the second portion 144 of the pivot arm 140 at least partially surrounds. In this example, the groove 164 has opposing convex portions 166. However, the walls forming the groove 164 may have another contour (e.g., concave or parallel to one another).

Referring back to FIG. 1, the valve assembly 100 includes a primary bushing 168 and a secondary bushing 170. Additional bushings 172 may also be provided. The primary bushing 168 surrounds the primary valve shaft 110 and is disposed within the bore 103 and the secondary bushing 170 surrounds the secondary valve shaft 112 and is disposed within the bore 103. The bushings 168, 170 have grooves 174 that are adapted to receive corresponding pins 176. The pins 176 may secure the longitudinal location of the bushings 168, 170 within the bore 103.

The valve assembly also includes a primary-torsion spring 178 and a secondary torsion spring 180. In the example shown, the primary-torsion spring 178 is arranged to bias the primary valve shaft 110 and the secondary torsion spring 180 is arranged to bias the secondary valve shaft 112.

FIG. 5 illustrates a valve assembly 200 assembled in accordance with a second disclosed example of the present invention. The valve assembly 200 is similar to the valve assembly 100 of FIG. 1. In contrast, the orientation of the clutch actuator 136 is reversed and a heat shield 202 is provided. So configured, the clutch actuator 136 is disposed closer to the coolant flow path 107 of the valve body 101.

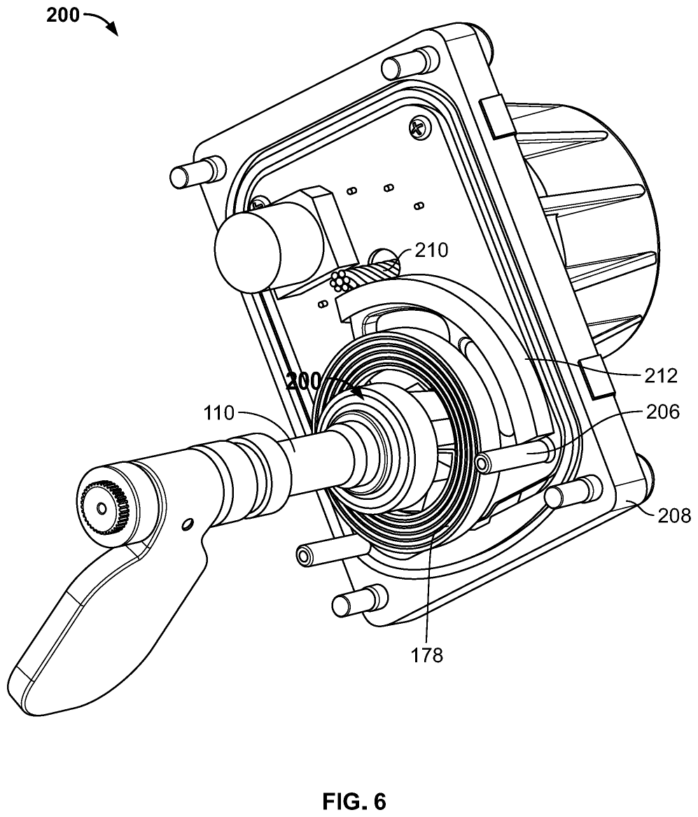

FIG. 6 illustrates an isometric view of a portion of the valve assembly 200 of FIG. 5. As shown, the primary-torsion spring 178 is coupled between a post 206 extending from a cover 208 of the rotary actuator 102 and the primary valve shaft 110. A pinion 210 of the rotary actuator 102 is also illustrated and arranged to engage a gear 212 to rotate the primary valve shaft 110.

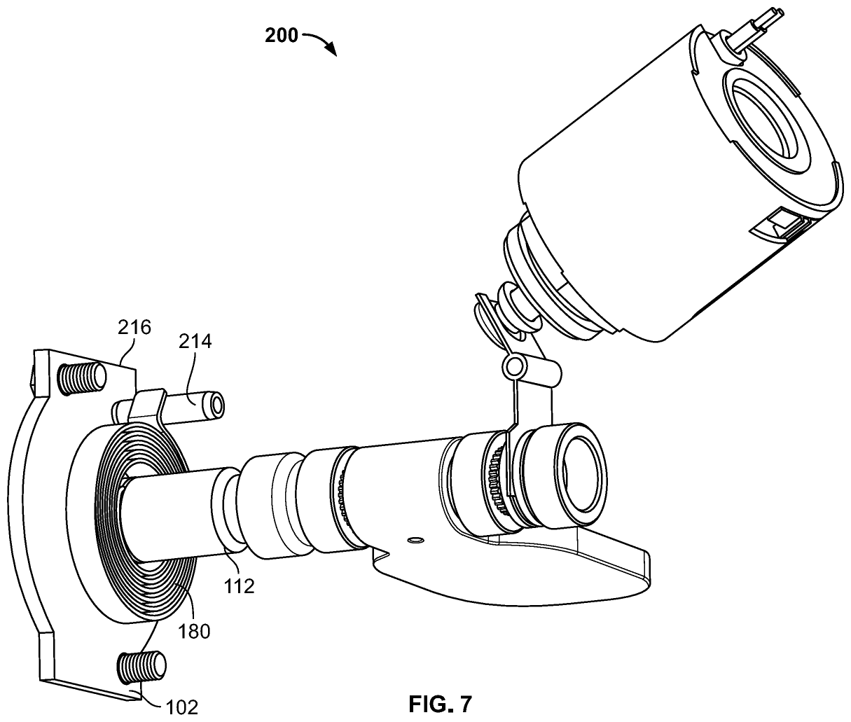

FIG. 7 illustrates an isometric view of a portion of the valve assembly 200 of FIG. 5. As shown, the secondary torsion spring 180 is coupled between a post 214 extending from a cover 216 of the valve body 101 and the secondary valve shaft 112.

From the foregoing, it will be appreciated that the above disclosed apparatus, methods, and articles of manufacture enable valve assemblies to be produced using less weight and less thermal mass. The disclosed examples also improve exhaust gas recirculation (EGR) and/or reduce engine complexity. Thus, the valve assemblies disclosed allow for a reduction in the package size, an integrated design, increased efficiency and provide a better value as compared to some known examples. The valve assemblies may be used with vehicles including a manifold and a turbo charger (e.g., diesel vehicles, commercial vehicles). One of the shafts (e.g., the primary valve shaft) may be adapted to provide proportional control for exhaust gas recirculation and another one of the shafts (e.g., the secondary valve shaft) may be adapted to control exhaust gas flow directly to the turbo charger. In such examples, the valve assemblies may provide higher efficiency and control during start up (cold) and operating conditions.

While implementation on a vehicle is mentioned, the disclosed examples may also be applied to other industries including, for example, Oil & Gas, Food & Beverage, Fluid Control, etc.

Further, while several examples have been disclosed herein, any features from any examples may be combined with or replaced by other features from other examples. Moreover, while several examples have been disclosed herein, changes may be made to the disclosed examples within departing from the scope of the claims.

What is claimed is:

1. A valve assembly, comprising:
a valve body comprising:
a bore;
a primary flap opening disposed adjacent to the bore; and
a secondary flap opening disposed adjacent to the primary flap opening;
a primary valve shaft disposed within the bore and having a primary end portion;
a secondary valve shaft disposed within the bore and having a secondary end portion facing the primary end portion of the primary valve shaft;
a primary flap disposed within the primary flap opening and coupled to the primary valve shaft;
a secondary flap disposed within the secondary flap opening and coupled to the secondary valve shaft; and
a clutch shiftable between a first position, in which the clutch is spaced from one of the primary and secondary end portions, such that the primary valve shaft is movable independently of the secondary valve shaft, and a second position, in which the clutch engages each of the primary and secondary end portions, such that the secondary valve shaft is movable with the primary valve shaft.

2. The valve assembly of claim 1, wherein each of the primary and secondary end portions comprises external splines and wherein the clutch comprises a clutch ring having internal splines that engage the external splines when the clutch ring is in the second position.

3. The valve assembly of claim 1, wherein each of the primary and secondary end portions comprises internal splines and wherein the clutch has external splines that engage the internal splines when the clutch is in the second position.

4. The valve assembly of claim 1, further comprising a rotary actuator coupled to the primary valve shaft to control a position of the primary valve shaft.

5. The valve assembly of claim 1, further comprising a clutch actuator adapted to shift the clutch between the first position and the second position.

6. The valve assembly of claim 5, wherein the clutch comprises an external groove, further comprising a pivot arm comprising a first portion and a second portion, the first portion of the pivot arm coupled to the clutch, the second portion of the pivot arm coupled to the clutch actuator, and wherein responsive to actuation by the clutch actuator, the first portion of the pivot arm engages a wall of the external groove of the clutch, thereby driving the clutch to the second position.

7. The valve assembly of claim 6, wherein the valve body comprises an access opening defined by the valve body between the primary flap opening and the secondary flap opening and providing access to the bore, the first portion of the pivot arm extending through the access opening of the valve body.

8. The valve assembly of claim 7, further comprising an actuator coupling comprising a flange and a housing having a bore, the flange coupled to the valve body and having an access opening aligned with the access opening of the valve body, the clutch actuator having an actuator stem and coupled to the housing of the actuator coupling, the actuator stem extending into the bore of the housing of the actuator coupling and coupled to the second portion of the pivot arm.

9. The valve assembly of claim 8, wherein the actuator stem has a groove, the second portion of the pivot arm at least partially surrounding the groove.

10. The valve assembly of claim 1, further comprising a primary torsion spring and a secondary torsion spring, the primary torsion spring arranged to bias the first portion of the primary valve shaft, the secondary torsion spring arranged to bias the second portion of the secondary valve shaft.

11. The valve assembly of claim 1, wherein the secondary torsion spring comprises a first portion and a second portion, the first portion of the secondary torsion spring coupled to the valve body, the second portion of the secondary torsion spring coupled to the secondary valve shaft.

12. A valve assembly, comprising:
a valve body comprising:
a first portion and a second portion;
a bore comprising a first-bore portion and a second-bore portion;
a primary-flap opening; and
a secondary-flap opening;
a primary actuator coupled to the first portion of the valve body;
a primary-valve shaft disposed within the first-bore portion and having a first portion and a second portion, the first portion of the primary-valve shaft coupled to the rotary actuator and the second portion of the primary-valve shaft having external splines;
a secondary-valve shaft disposed within the second-bore portion and having a first portion and a second portion, the first portion of the secondary-valve shaft having external splines and facing the second portion of the primary-valve shaft;
a primary flap disposed within the primary-flap opening and having a yoke coupled to the second portion of the primary-valve shaft;
a secondary flap disposed within the secondary flap opening and having a yoke coupled to the first portion of the secondary-valve shaft; and
a clutch ring having internal spines,
wherein the clutch ring is shiftable between surrounding and having the internal splines mate with the external splines of one of the external splines of the primary-valve shaft or the external splines of the secondary-valve shaft to surrounding and having the internal splines of the clutch ring mate with both of the external splines of the primary-valve shaft and the external splines of the secondary-valve shaft.

13. The valve assembly of claim 12, further comprising an clutch actuator adapted to shift the clutch ring between surrounding and having the internal splines mate with the external splines of one of the external splines of the primary-valve shaft or the external splines of the secondary valve shaft to surrounding and having the internal splines of the clutch ring mate with the external splines of both of the external splines of the primary-valve shaft and the external splines of the secondary valve shaft.

14. The valve assembly of claim 13, wherein the clutch actuator comprises one of a solenoid valve, a diaphragm actuator, a lead screw, a pneumatic actuator, or a pneumatic actuator.

15. The valve assembly of claim 13, further comprising a coupling between the clutch actuator and the clutch ring.

16. The valve assembly of claim 15, wherein the coupling comprises a pivot arm or an arm shiftable relative to a longitudinal axis of the primary-valve shaft and the secondary-valve shaft.

17. A valve assembly, comprising:
a valve body, comprising:
a first portion and a second portion;
a bore;
a primary opening disposed adjacent the bore; and
a secondary opening disposed adjacent the primary opening and the bore; and
a primary valve shaft disposed within the bore and having a primary end portion;
a secondary valve shaft disposed within the bore and having a secondary end portion facing the primary end portion of the primary valve shaft;
a primary valve member movable relative to the primary opening and coupled to the primary valve shaft;
a secondary valve member movable relative to the secondary opening and coupled to the secondary valve shaft; and
a clutch shiftable between a first position enabling the primary valve shaft to move independently of the secondary valve shaft, and a second position enabling the secondary valve shaft to move with the primary valve shaft.

18. The valve assembly of claim 17, wherein the secondary valve member comprises one of a valve flap, a disk, or a valve plug.

19. The valve assembly of claim 17, wherein at least one of the primary end portion or the secondary end portion has a keyway and the clutch has a key that mates with the keyway when the clutch is in the second position.

20. The valve assembly of claim 17, wherein at least one of the primary end portion or the secondary end portion has a female portion and the clutch has a male portion that mates with the female portion when the clutch is in the second position.
